(19) United States
(12) Patent Application Publication
(10) Pub. No.: US 2008/0116844 A1
(43) Pub. Date: May 22, 2008

(54) Method, system and device for ignition of motor-vehicle engines with flat batteries

(76) Inventors: Shimon Dabush, Modiin (IL); Uzi Ezra Havosha, Tel Aviv (IL)

Correspondence Address: UZI EZRA HAVOSHA & PARTNERS, HADAR-DAFNA HOUSE 39 SHAOUL HAMELECH STREET, TEL AVIV, 64928, omitted

(21) Appl. No.: 11/602,701

(22) Filed: Nov. 22, 2006

(51) Int. Cl. H02J 7/14; H02J 7/00; H02K 5/00

(52) U.S. Cl. 320/104; 322/1; 320/107

(57) ABSTRACT

A cable with two separated wires with one end connected to a plug capable of fitting into the socket of the cigarette lighter, where the said lighter socket is connected to the battery of the vehicle. The other end of the cable is either a plug capable of fitting into the socket of the cigarette lighter socket of a different vehicle or clips to attach to battery terminals for the purpose of starting the engine of one vehicle from another. The said cable could be on a retractable reel of cable wire.

An electricity generator operated by hand or by foot or by a motor from within the vehicle, to charge a flat battery. The said generator being connected directly to the battery of the vehicle or via the cigarette lighter socket.

### FIELD OF THE INVENTION

This invention is in the field of combustion engines and particularly in the field of ignition of motor vehicles whose batteries are dead or without sufficient power to start an engine.

### BACKGROUND OF THE INVENTION

It is well known that in the motor-trade that the charge in vehicle-batteries can fade and that they lose their power. This can happen because a device in the vehicle, which constantly draws power, has been left ignited when the engine is not running, for example, the headlights. This problem is especially acute in countries which require headlights to be lit when driving during day-light hours.

Another possibility for the battery to lose its power is due to the constant discharge of the battery by devices, such as alarms which are constantly draining small amounts of power from the vehicle battery. If the vehicle is not used for a number of days, then it is quite possible that there will not be left enough power to activate the starter-motor. The starter-motor requires a large amount of power in order to turn over the engine before it will start.

Another possible cause for the battery to be “run-down” can be due to the fact that the vehicle is being used mainly for short journeys. The starter-motor is frequently used to restart the engine, and as the starter-motor uses a lot of power every time that it is used, the battery quickly loses its power before there is time for the alternator to recharge the battery.

Another possibility for the battery not to be fully charged could also be due to the fact that the physical condition of various and differing components—the fan-belt slipping or not being taut, the alternator being faulty—and even a combination of all these factors can contribute to the battery not being completely charged, thus unable to supply enough power to the starter motor.

Alternatively, the battery can “die” of old age. It has in it components that gradually wear out or are used up as part of the normal wear and tear.

When faced with such a situation, there are different methods commonly used to try to restart the vehicle, each of which presents their own differing problems.

One common method is to try to push-start the vehicle. Should the vehicle have an automatic gearbox, then this possibility cannot be used as such vehicles do not have a clutch. In such a case, one of the following methods could be used.

Push-starting the vehicle presents its hazards, it is very difficult when one is alone, as when the vehicle has finally started moving one then has to jump physically into the vehicle, depress the clutch, engage a gear and release the clutch, as the vehicle is still moving. There could also be other traffic on the road, which would make it difficult and even dangerous. The vehicle could be facing uphill on the road, requiring this starting procedure to be done when the vehicle is moving backwards. The vehicle sometimes stalls again after having started, thus requiring to start the process over again.

Another difficulty could be that the vehicle is on muddy ground, or on a sand-dune, either of these conditions can compound the difficulties of a push-start. Another possibility is that there is no room physically to start pushing the vehicle as there are other vehicles or objects parked too close.

Another possibility is that the vehicle is physically too heavy to be pushed, even with the aid of many people.

Another possibility—using the same principle is to tow-start the vehicle, but for this also is required an additional vehicle capable of towing the first vehicle and a suitable tow rope and place on each vehicle to firmly attach the said rope.

Under such circumstances one has to rely on other methods. One such common method is to use jumper cables, connecting these cables to the battery of another vehicle. This too also has its hazards, as the cables have to be connected properly, in the right order and to the correct terminals. Failure to ensure that this operation is performed correctly can cause further financial and physical damage to one or both vehicles.

Another problem when doing this is also that the engine compartments of both vehicles have to very close to each other. Sometimes this is not physically possible. Many examples of this can be cited, for example on a busy high-way it would be dangerous for the donor vehicle to stand, in parallel in the traffic lane, alongside the stationary vehicle. It would be equally dangerous for the assisting vehicle to turn around to face the opposite direction to enable the two engines to be close one to the other.

Another possibility could be that the vehicle, which now has a weak battery, was parked nose first in a garage or even in a public parking lot, but it is not possible to park another vehicle in front of stalled vehicle.

Another hazard, when using either of these methods, is that persons are on the roadway, vulnerable to passing traffic. Many instances of injury and death have occurred in similar circumstances. Dealing with such problems in rain or other difficult weather conditions or in the dark, make the known methods of emergency engine starting a difficult and potentially dangerous procedure.

This invention is designed to circumvent, answer and overcome such problems, enabling even the driver, who is alone, to start the vehicle safely without having to enlist the aid of other persons. In some of the embodiments of this invention the driver can start the vehicle engine when the vehicle battery is flat even without leaving the vehicle.

In an alternative embodiment of this invention, two vehicles are needed but the cable connection between the two vehicles is a simpler and safer method than presently known. There may need to be changes in the electrical wiring in the vehicle to allow the larger voltages needed to start a vehicle. Army vehicles are particularly vulnerable to flat batteries as often the battery power is used to power equipment when the engine is off causing the battery to drain its power. Then the vehicle is required to move at short notice and often under time pressure where other vehicles are not available to help. In this kind of situation a method of independently starting the engine that has a flat battery is not only a convenience but may save lives.

This invention therefore comes to fill a gap in existing 15 technology and will have a place in the private and commercial markets.

### SUMMARY OF THE INVENTION

It is to be understood that both the foregoing general description and the following detailed description present embodiments of the invention, and are intended to provide an overview, or framework, for understanding the nature and character of the invention as it is claimed. The accompanying drawings are included to provide a further understanding of the invention, and are incorporated into and constitute part of this specification. The drawings illustrate various embodiments of the invention and, together with the description serve to explain the principles and operations of the invention

An embodiment of the invention includes a mechanical electromechanically operated device able to generate electrical power for the purposes of starting a vehicle engine. This could be what is commonly referred to as a dynamo, alternator or generator. Herein, when reference is made to a generator the intention is to one of these three devices or a device that performs the same function, namely the production of electrical energy from mechanical forces.

The generator has a crank, which could be operated by hand, which would convert mechanical energy to electrical energy. Another option is for the crank to be operated by foot. This embodiment of this invention can be installed and operated within the passenger compartment of the vehicle, thus making it unnecessary for anyone to leave the vehicle.

Another object of the invention would be to have an electric motor, powered by an additional battery which would operate the said crank.

The power generated by this generator could be connected to the battery of the vehicle using a cable connecting the device to the cigarette lighter of the vehicle or directly to the vehicle battery.

Another object of the invention, especially when using the above method, is that the said additional battery of this device could be recharged automatically, through its connection via the cigarette lighter or a connection with the vehicle battery, when the engine is running normally.

Another possibility could be that the said cable could be connected permanently between the said generator and the starter motor of the vehicle, thus providing power directly to the starter motor to restart the vehicle. In this situation, it would be necessary to have heavy-duty cables between the generator and the starter-motor. Where connections are via the cigarette lighter of the vehicle the electrical connections between the said cigarette lighter and the battery will need to be heavy duty.

Another possibility is that a vehicle could be fitted with a long external cable, enabling the possibility of providing power to other vehicles or receiving power from other vehicles. The ends of this cable would be fitted with plugs enabling them to plug into the cigarette lighter socket of another vehicle or have conventional terminal clips and thus being able to start other vehicles or be started by other vehicles, as the case may be. Here too the electrical wiring would need to be heavy duty. The said electrical wiring could remain unchanged if the electrical current produced by the generator is sufficiently small not to damage the other electrical systems in the vehicle that are connected to the cigarette lighter socket. However such a small current would take relatively a long time to charge the vehicle battery.

In order to start the vehicle quickly a high current is needed. In this case it could be preferable to ensure that no other electrical devices are connected to the said socket, in order to avoid damage or to have a separate cigarette lighter socket with heavy duty wires with a connection direct to the battery of the vehicle. Only this latter cigarette lighter socket would be used when starting the vehicle engine from external power sources, as is described herein.

Another object of this invention is for the device to be portable, or alternatively a self-contained unit, enabling it to be transferred from the vehicle in which it has been installed, when necessary.

Another object of this invention is for the device to be permanently fixed in a vehicle to ease its use when needed to be connected to another vehicle. The electrical connecting cable would simply be extended to reach the other vehicle's electrical system.

### BRIEF DESCRIPTION OF DRAWINGS

The accompanying drawings, which are incorporated in and form a part of this specification, illustrate embodiments of the invention and, together with the description, serve to explain, by way of example only, the principles of the invention:

FIG. 1 is a drawing of the conventional prior art connecting cables.

FIG. 2 is a drawing of a cable of this invention.

FIG. 3 is a drawing of the cable on a retractable reel.

FIG. 4 is a schematic side view of a hand operated generator of electricity with its connector made to fit into the cigarette lighter socket.

FIG. 5 is a drawing of the foot pump of a foot operated generator.

FIG. 6 is a cross-sectional view of the generator used with this invention.

### DESCRIPTION OF PREFERRED EMBODIMENTS

As will be appreciated the present invention is capable of other and different embodiments than those discussed above and described in more detail below, and its several details are capable of modifications in various aspects, all without departing from the spirit of the invention. Accordingly, the drawings and description of the embodiments set forth below are to be regarded as illustrative in nature and not restrictive.

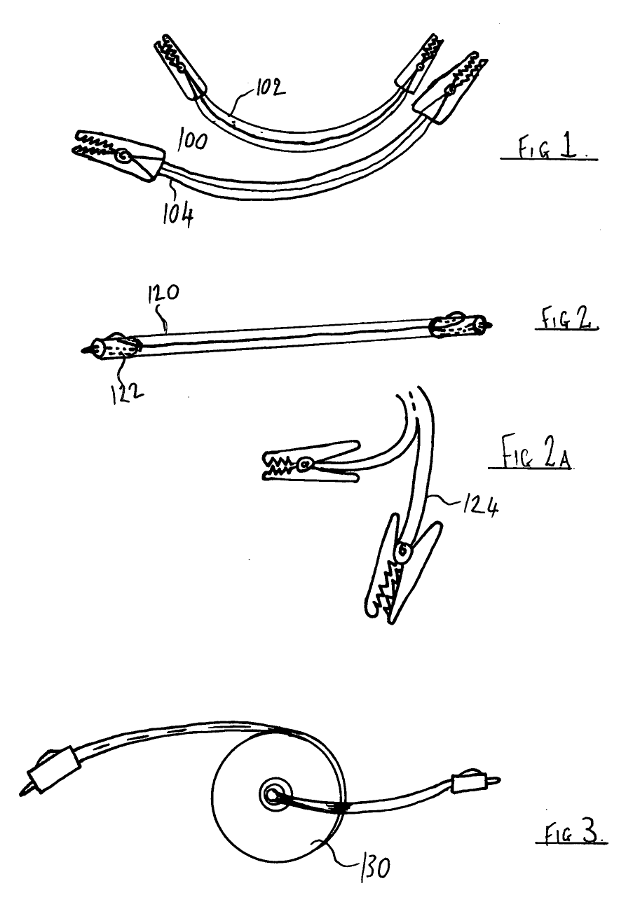

FIG. 1 shows a conventional set of cables 100 used to connect the battery of a running engine with the battery of a vehicle with a flat battery. The cables are used in parallel, one 102 from the positive terminal of the charged battery to the positive terminal of the flat battery and the other 104 from the negative terminal of the charged battery to the negative terminal of the flat battery.

FIG. 2 shows a cable 120 of this invention with a separation between the wires for the positive and negative charges. This cable has connector plugs 122 at each end of the cable 120 suitable to fit into the socket of the cigarette lighter of vehicles. Alternatively, one end of this cable could be fitted with conventional clips FIG. 2A 124 for attaching directly to battery terminals.

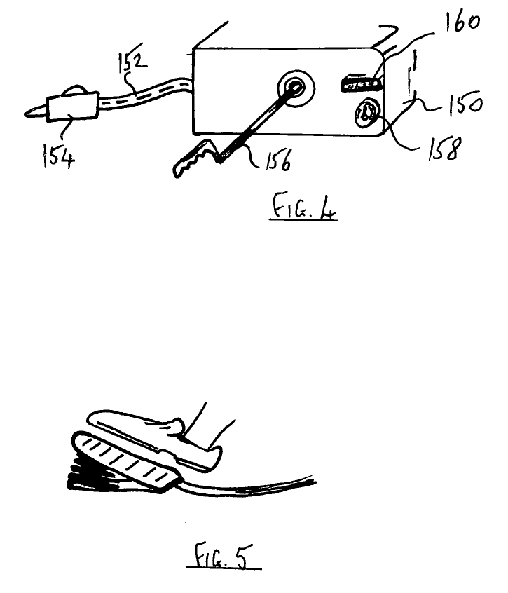

FIG. 3 shows the cable of this invention on a cable reel 130 which could be spring loaded or manually wound for ease of retraction.

FIG. 4 shows a generator 150 used with this invention. It has an extendable cable 152 with a plug 154 suitable to fit a cigarette lighter socket or conventional clips as shown in FIG. 2A for direct connection to the vehicle battery. It has a crank handle 156 which when turned generates electricity. A voltage gauge 158 and an amp meter 160 indicate the voltage and amperage produced when the handle is cranked.

FIG. 5 shows a foot pump that could be used instead of the hand crank to generate the electricity.

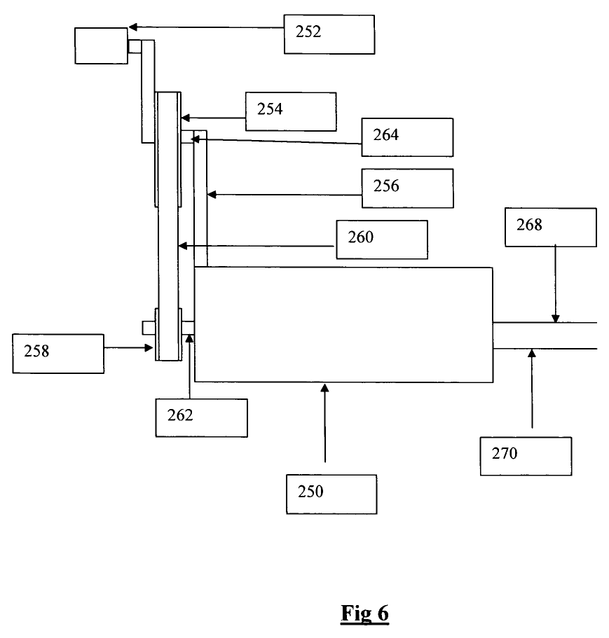

FIG. 6 shows the cross-section of a generator 250, to which on upper part of the body 250 is attached a stand 256. The lower part of the stand 256 is attached by screws or welded on to the body of the generator 250. At the upper end of the stand 256 is a free-rotating spindle 264 on to which is affixed a larger diameter pulley wheel 254. The spindle 264 extends beyond the large pulley-wheel 254. At the end of the spindle 254 is attached, perpendicularly the handle arm and a handle 252. The generator 250 could be kept and operated within the passenger compartment of the vehicle.

Beyond the body of the generator 250, on the same side as the handle 252, extends a rotating spindle 262. To the rotating spindle 262 is fixed a small pulley wheel 258. The small pulley wheel 258 and the large pulley wheel 254 are directly vertically above each other and in-line. A belt 260 is mounted on the large pulley wheel 254 and on the small pulley wheel 258 so that rotation of the large pulley wheel 254 will cause the small pulley wheel 258 also to rotate, but at a faster speed, proportionately to the difference in size between the said two pulley wheels. On the opposite side of the small spindle 262 are connected the positive cable 268 and the negative cable 270 which will transfer the electricity generated to the car-battery via the cigarette-lighter or directly to the vehicle battery. When the vehicle engine is required to be started using the present invention, the handle 252 is rotated which will cause the upper pulley wheel 254 to rotate. This rotation will cause the pulley-belt 260 to rotate and thus rotate the lower pulley-wheel 258. This drives the lower spindle 262 to which is connected the armature within the generator body 250 causing electricity to be generated. The electricity thus generated is transferred via the cables 268 and 270 to the vehicle battery directly or via the cigarette-lighter socket. The electricity thus generated will gradually recharge the car-battery until it will have enough power for the starter motor.

A further option is to replace the handle with a separate electric motor, powered by a separate re-chargeable battery, which would drive the upper spindle 254. This re-chargeable battery could be kept in a state of charge by being connected to the battery of the vehicle when in use and thereby gaining charge.

The present invention is not intended to be limited to the embodiments described above, but to encompass any and all embodiments within the scope of the following claims.

1. A method system and device for igniting internal combustion engines by creating a source of electricity comprising:
a) a generator for generating electricity from mechanical energy,
b) a geared pulley system to enable a smaller input force to create a greater output force in order to operate the said generator,
c) an electrical connection between the said generator and the said combustion engine
d) at least one of the electrical contact connections to the said combustion engine is through the electrical cigarette lighter socket of a motor vehicle,
thereby completing an electrical circuit and enabling internal combustion engines to be ignited when their existing igniting systems fail.

2. A method system and device as claimed in claim 1 wherein the internal combustion engine is the engine of a motor vehicle.

3. A method system and device as claimed in claim 1 wherein the said input force is manually operated whether by hand or by foot.

4. A method system and device as claimed in claim 1 wherein the said input force is a pumping action using the hand or foot.

5. A method system and device as claimed in claim 1 wherein the said generator has a gauge to measure the current and a gauge to measure the voltage produced by the said generator.

6. A method system and device as claimed in claim 5 wherein the said generator is detachably fixed inside the said vehicle and may be operated therein.

7. A method system and device as claimed in claim 1 wherein the said generator creates electricity by means of a rotational force rotating coils of electricity-conducting wires inside a magnetic field.

8. A method system and device as claimed in claim 1 wherein the said input force is electrically operated from the power of a battery-operated motor that produces the rotational force required to create electricity in the said generator.

9. A method system and device as claimed in claim 8 wherein the said input force is electrically operated by a battery connected to the cigarette lighter socket of a motor vehicle or by transferring the electricity directly to the said motor vehicle battery or to the starter ignition or to the engine of the said motor vehicle for the purpose of creating an ignition.

10. A method system and device as claimed in claim 9 wherein the said battery is re-chargeable.

11. A method system and device as claimed in claim 10 wherein the said re-chargeable battery is charged by being connected to the said engine's electrical system when the engine is working.

12. A method system and device for igniting internal combustion engines of motor vehicles by connecting the electrical system of the said engine via the cigarette lighter socket to the electrical system of another motor vehicle via its cigarette lighter socket using electrical plugs made to fit in the said sockets.

13. A method system and device as claimed in claim 13 wherein at least one of the said connections is via the motor vehicle battery terminals using, for example, spring loaded crocodile clips to make the necessary electrical connection.

14. A method system and device as claimed in claims 1, 12 and 15 wherein the said cigarette lighter socket and plug is any kind of electrical connection to the battery of the vehicle engine required to be ignited.

15. A cable comprising:
a) two wires or two groups of wires, suitable for conducting electricity both being connected to a plug made to fit in the electrical cigarette lighter socket, one being connected to the positive electrical charge and the other being connected to the negative electrical charge and,
b) a connection at one end of the said cable suitable to fit the electrical cigarette lighter socket commonly found in motor vehicles or connect directly to the flat battery terminals,
c) a connector, for example, a plug to fit an electrical cigarette lighter socket or a spring loaded crocodile clips, at the other end of the said cable to connect to a source of electrical energy,
whereby there will be a completed electrical circuit when the said plugs are inserted in the said sockets or said clips are connected to battery terminals and whereby motor vehicle engines with flat batteries can be started from the battery of another motor vehicle engine or from other source of electrical energy.

16. A cable as claimed in claim 15 wherein the said positive and negative wires are separated by insulating material.

17. A cable as claimed in claim 15c wherein the said source of electrical energy is a generator of electricity.

18. A cable as claimed in claim 15c wherein the said source of electricity is a battery, other than the flat battery of the said motor vehicle, situated in the motor vehicle.

19. A cable as claimed in claim 18 wherein the said battery is rechargeable.

20. A cable as claimed in claim 19 wherein the said battery recharging is achieved by the said battery being connected to the motor vehicle electrical system when the motor vehicle engine is working.

21. A cable as claimed in claim 15c wherein the said source of electricity is the battery of another motor vehicle and wherein the connection to the said other vehicle battery is via the socket of the electrical cigarette lighter.

22. A cable as claimed in claim 15c wherein the said source of electricity is the battery of another motor vehicle and wherein the connection to the said other vehicle is direct to the said battery of the said other vehicle, for example, using spring loaded crocodile clips attached to the terminals of the said battery.

23. A cable as claimed in claim 15 wherein the said cable is stored on a spring loaded reel that collects slack cable, if any, and releases cable length when the said cable is pulled in a direction away from the said reel.

24. A cable as claimed in claim 23 wherein the said reel is wound with the aid of a motor.
